(19) United States
(12) Patent Application Publication
(10) Pub. No.: US 2026/0172846 A1
(43) Pub. Date: Jun. 18, 2026

(54) DYNAMICALLY DEPLOYED COMMUNICATION NETWORK PARADIGM USING MESH TOPOLOGY FOR EXTREME ENVIRONMENTS

(71) Applicant: Arizona Board of Regents on Behalf of the University of Arizona, Tucson, AZ (US)

(72) Inventors: Wolfgang Fink, Tucson, AZ (US); Mark Tarbell, Tucson, AZ (US)

(21) Appl. No.: 19/127,005

(22) PCT Filed: Nov. 3, 2023
(86) PCT No.: PCT/US2023/078750

§ 371 Date: May 2, 2025

Related U.S. Application Data
(60) Provisional application No. 63/422,110, filed on Nov. 3, 2022.

(51) Int. Cl. H04W 16/18; H04W 24/04; H04W 84/18

(52) U.S. Cl. CPC H04W 16/18; H04W 24/04; H04W 84/18

(57) ABSTRACT

Various examples are provided for dynamically deployed communication networks. In one example, a method includes deploying an agent in communication with a base platform; traversing an area by the agent, where one or more mesh nodes deployed in the area form a dynamically deployed communication network (DDCN); and maintaining communication between the agent and base platform via at least a portion of the one or more deployed mesh nodes of the DDCN. The mesh nodes can be autonomously deployed by the agent during traversal or can be deployed prior to traversal of the agent.

### CROSS REFERENCE TO RELATED APPLICATIONS

This application claims priority to, and the benefit of, co-pending U.S. provisional application entitled “Dynamically Deployed Communication Network Paradigm Using Mesh Topology for Extreme Environments” having Ser. No. 63/422,110, filed Nov. 3, 2022, which is hereby incorporated by reference in its entirety.

### BACKGROUND

The next frontier of planetary exploration arguably is the exploration of hazardous surface environments (e.g., craters, valleys, lava flows), subsurface environments (e.g., caves and lava tube caves), and aquatic/subaquatic environments (e.g., lakes, rivers, and oceans). One of NASA's Space Technology Grand Challenges (National Aeronautics and Space Administration (NASA), ‘Space Technology Grand Challenges’. 2010)—“All Access Mobility” is to “Create mobility systems that allow humans and robots to travel and explore on, over or under any destination surface.” The problem stated is the following: “Exploration of comets, asteroids, moons and planetary bodies is limited by mobility on those bodies. Current robotic and human systems cannot safely traverse a number of prevalent surface terrains. Current systems travel slowly, requiring detailed oversight and planning activities. Consequently, these systems are often limited to exploring areas close to their original landing site.” Candidate lava tube caves have been identified on the Moon and Mars, raising possibilities for planetary exploration, habitat construction for future astronauts, and astrobiology (e.g., extinct/fossilized and/or extant life). In a similar vein, the exploration and characterization of unmapped underground voids, i.e., underground mine workings (e.g., tunnels, shafts, etc.), tunnel systems in a military setting, as well as rugged terrain devoid of direct line-of-sight communication pose a global challenge.

### SUMMARY

Aspects of the present disclosure are related to dynamically deployed communication networks. In one aspect, among others, a method, comprising deploying an agent in communication with a base platform; traversing an area by the agent, wherein one or more mesh nodes deployed in the area form a dynamically deployed communication network (DDCN); and maintaining communication between the agent and base platform via at least a portion of the one or more deployed mesh nodes of the DDCN. In one or more aspects, the one or more mesh nodes can be autonomously deployed by the agent during traversal of the agent in the area, the one or more mesh nodes can be autonomously deployed prior to traversal of the agent in the area, or both. The one or more mesh nodes can be autonomously deployed by an aerial platform, the one or more mesh nodes can be autonomously deployed by the base platform, or both. At least one additional mesh node, optionally, can be autonomously deployed by the agent during traversal of the agent in the area.

In various aspects, the agent can be deployed by the base platform, the agent can be deployed by an aerial platform, or agents can be deployed by both. The agent can be an intra-cave-explorer (ICE) agent or an intra-liquid explorer (ILE) agent. The agent can deploy a mesh node in response to, for example, a received signal strength from the base platform or from an adjacent mesh node of the DDCN. The agent can deploy the mesh node when the received signal strength falls below a defined threshold. The agent can deploy two or more mesh nodes in response to the received signal strength. The method can comprise deploying another agent from the base platform; traversing the area by the other agent, wherein at least one mesh node is autonomously deployed by the other agent at a different location during the traversal of the other agent, the at least one mesh node extending the DDCN; and maintaining communication between the other agent and base platform via the at least one mesh node. The at least one mesh node can be in communication with a mesh node of the one or more deployed mesh nodes. The other agent can maintain communication with the base platform via at least a portion of the one or more deployed mesh nodes while traversing the area before deploying the mesh node. At least one mesh node can allow bidirectional information exchange between the agent and the other agent via at least a portion of the one or more mesh nodes.

In one or more aspects, the method can comprise traversing the area by the base platform after deployment of the agent, wherein communication between the agent and base platform is dynamically maintained via the DDCN. The one or more deployed mesh nodes can form a distributed instrument array configured to provide sensor information to the base platform, to one or more agent, or both via the DDCN. The area can be a non-liquid environment. The area can be a cave, lava tube cave, or underground mine working. The area can be a subsurface liquid environment. The agent can comprise a magazine configured to store and deploy the one or more mesh nodes. The magazine or storage area/compartment or storage can be a pressure operated linear magazine that dispenses the one or more mesh nodes. The pressure can be provided by at least one of a spring, a strut, compressed gas, liquid, or electromagnetic field or pulse. Information gathered by the agent can be communicated to the base platform for processing. The base platform can remotely control operation of the agent. The base platform and at least one deployed agent can have bidirectional information exchange. In yet another example, the deployed agent and at least one other deployed agent can have bidirectional information exchange.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates examples of caves and lava tubes, in accordance with various embodiments of the present disclosure.

FIG. 2 illustrates an example of a Dynamically Deployed Communication Network (DDCN) topology, in accordance with various embodiments of the present disclosure.

FIGS. 3A-3D illustrate an example of a deployment sequence of an ICE (intra-cave explorer) agent from a base platform, in accordance with various embodiments of the present disclosure.

FIGS. 4A-4L illustrate examples of mesh network deployment scenarios, in accordance with various embodiments of the present disclosure.

FIGS. 5A-5C illustrate examples of mesh network pre-deployment or simultaneous deployment scenarios, in accordance with various embodiments of the present disclosure.

FIGS. 6A-6D illustrate examples of base platforms (e.g., rovers), lake landers, ICE agents, and ILE (intra-liquid explorer) agents, in accordance with various embodiments of the present disclosure.

FIG. 7 is an image of an Espressif ESP32-based microcontroller and a Raspberry Pi Zero W which can be used for ad hoc mesh network communication, in accordance with various embodiments of the present disclosure.

FIGS. 8A-8B illustrate an example of a deployment mechanism for mesh nodes in the form of a linear magazine and an associated lever-based discharge mechanism, in accordance with various embodiments of the present disclosure.

### DETAILED DESCRIPTION

Disclosed herein are various examples related to dynamically deployed communication networks. Mesh networks offer tremendous advantages over hardwired or fixed-point networks when there is a need to adapt the network topology in real time. Based upon a mesh network foundation, the disclosed DDCN paradigm can adapt its network topology to suit the environment at hand such as, but not limited to, caves, lava tubes, underground mine workings (e.g., tunnels, shafts, etc.), tunnel systems in military settings, rugged terrain devoid of direct line-of-sight communication, oceans, lakes, rivers, etc.

Reference will now be made in detail to the description of the embodiments as illustrated in the drawings, wherein like reference numbers indicate like parts throughout the several views.

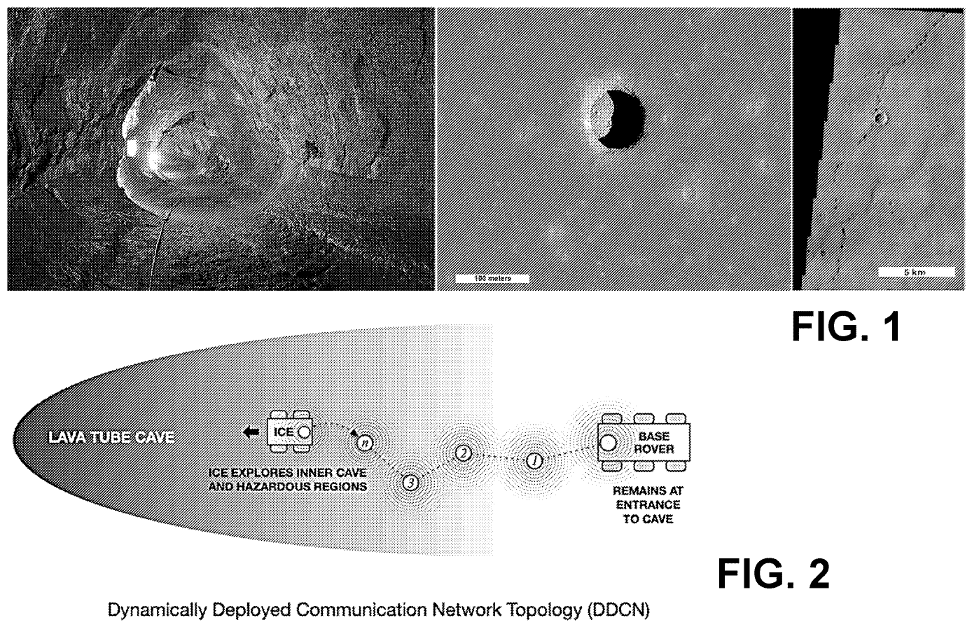

Lava tube caves such as the Nahuku (a.k.a. Thurston) lava tube on Kilauea, Hawaii (left image of FIG. 1) can be up to 14-15 m wide, though are often much narrower, and can extend for tens of kilometers. Lava tube caves on planetary bodies with reduced gravity compared to Earth are likely larger, and may be accessible, e.g., via skylights (i.e., openings due to collapsed lava crust). For example, the center image of FIG. 1 shows a pit (interpreted to be skylight into a lava tube) on the Moon, located within the Marius Hills (LROC image M122584310L) and the right image of FIG. 1 shows a possible lava tube located on Mars near Hadriaca Patera (THEMIS image V09784003, rotated by 90° clockwise, added scale bar is approximate).

Caves, and in particular deep lava tube caves, provide a possible refuge for life (e.g., extremophiles, algae, lichens) under challenging planetary surface conditions, and, as such, are of prime interest for astrobiological exploration. This is particularly relevant on Mars due to surface radiation (e.g., harmful cosmic and ultraviolet (UV) radiation) making survival of life forms exceedingly difficult on or near the surface. Lava tube caves on Mars may potentially contain pools of liquid water or ice and nutrients to support microorganisms, especially at low elevations. In general, lava tube caves may be suitable for habitats for astronauts and subsequent human settlement (e.g., NASA Artemis/Gateway program for the Moon) due to the possibility of water and/or other nutrients alongside the natural shielding from surface radiation, larger temperature variations, and impacts from space debris (e.g., meteorites). Sensing equipment or computer systems that must be shielded from radiation, temperature variations, and regolith dust may operate more safely inside lava tube caves. Thus, the rate of accomplishing science mission objectives could be increased significantly, especially regarding identifying extant or extinct/fossilized life (i.e., astrobiology).

Similarly, the existance of unmapped/uncharted underground mine workings (e.g., tunnels, shafts, etc.) pose a global problem for the mining industry at large. As such, the exploration and characterization of such underground mine workings is of prime importance, e.g., to ensure (a) overall operational safety of an underground mining operation, (b) safety for mine workers, (c) structural safety for new mine workings in the vicinity of existing but unmapped/uncharted legacy mine workings, and (d) successful drilling of new ventilation shafts in the presence of unmapped/uncharted legacy underground mine workings. Rugged terrain, devoid of direct line-of-sight communication, can also present challenges in military settings or during natural disasters, such as, but not limited to, earthquakes, tornadoes, hurricanes, floods, fires, etc.

In the same vein, the existence of subsurface oceans on celestial bodies known as ocean worlds has been backed by varying levels of evidence since the 1980s, but there has been no direct confirmation of these subsurface oceans. In particular, Europa, Enceladus, and Titan have stronger evidence such as planetary moment of inertia (for Europa), a plume of gas and ice (for Enceladus), and subsurface dielectric conductivity (for Titan) to support the hypothesis that they have subsurface oceans. Nevertheless, the hypothesized depths of these subsurface liquid environments (i.e., anywhere from 1 km to 100 km) indicate the need for preparation for subsurface liquid environment exploration. Such environments are also shielded from radiation and in combination with the hypothesized presence of water, are additional candidate environments for finding extant or extinct/fossilized life.

A Dynamically Deployed Communication Network (DDCN) can be used in support of a distributed robotic multi-agent approach for planetary subsurface exploration.

DDCN directly addresses one of the ‘Space Technology Grand Challenges’. 2010 of NASA's Space Technology Grand Challenges (National Aeronautics and Space Administration (NASA)—“All Access Mobility.” The DDCN paradigm presented in this disclosure can lay the foundation for a distributed, fully integrated, multi-agent system exhibiting orchestrated, operational autonomy suitable for the enablement of the exploration of (a) treacherous surface regions (e.g., valleys, craters, lava flows, etc.) and (b) subsurface cavities (e.g., caves, lava tubes, underground mine workings, etc.). One or more mobile exploration agents can maintain communication to a base platform via a series of “Hansel & Gretel breadcrumbs”—ad hoc self-extending communication nodes, forming an interconnected mesh network, which can be autonomously deployed from the surface/subsurface exploration agent(s) as they reconnoiter a target region. As such, it directly addresses the 2015 NASA Technology Roadmap Technology Area 4.2: Mobility: “Reach and operate at a range of sites of scientific interest in extreme planetary environments or in free-space environments.” More specifically, this work addresses the sub-goal of 4.2.2: Below Surface Mobility: “Provides ability to access and explore natural or human-made features below the surface.”

### DDCN and Mesh Networking

Mesh networks offer tremendous advantages over hardwired or fixed-point networks when there is a need to adapt the network topology in real time. Based upon a mesh network foundation, the DDCN paradigm can adapt its network topology to suit the environment at hand. For the purposes of exploring a cave, for instance, a robotic mobile platform (designated as the “base platform”, e.g., a rover) may choose to remain outside the cave entrance and deploy one or more Intra-Cave Explorer (ICE) agents into the cave. Each base platform and each ICE agent can be fitted with its own dedicated onboard mesh node, and as such can be automatically integrated into the mesh network. Thus, each ICE agent already has an established pre-deployment communication channel with the base platform and can deploy small active mesh nodes called “breadcrumbs” behind/around it as it explores the cave. In this way, an active communications link to the base platform can be built and maintained dynamically, and can be extended with little or no interruption as the ICE agent(s) are deployed into the cave or region to be explored. FIG. 2 illustrates an example of a DDCN topology, which can create and extend the active communications link between remote agents while exploring unknown, potentially hazardous terrain.

### Considerations of DDCN Implementation

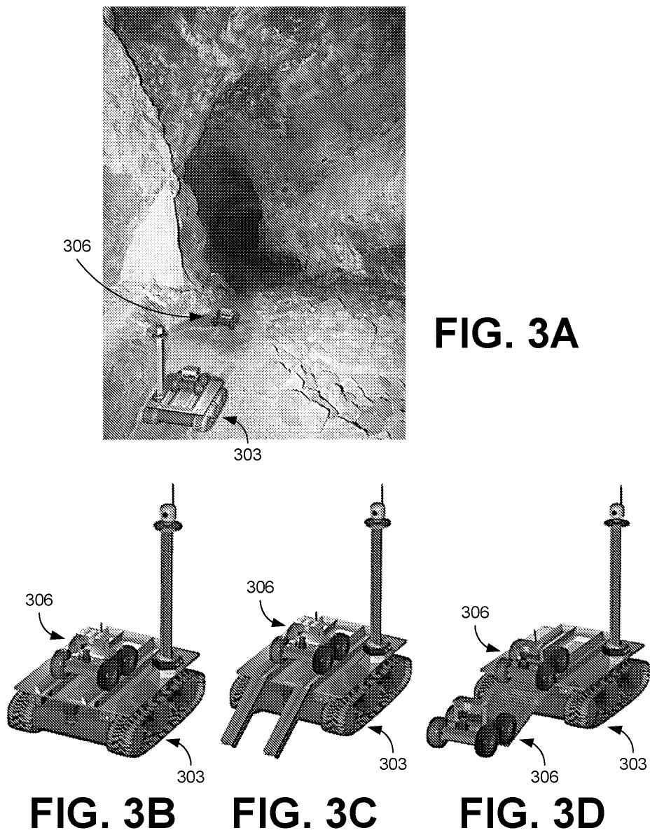

A multi-platform framework having operational autonomy can be deployed for the exploration of potentially hazardous terrain, such as craters, caves, lava tube caves, or underground mine workings. FIGS. 3A-3D illustrate an example of a deployment sequence with the base platform 303 entering, e.g., a cave or lava tube on a planet in the image of FIG. 3A. The base platform 303 can transport one or more ICE agents 306 as shown in FIGS. 3A-3B and can deploy intra-cave-explorer (ICE) agents 306, either singly or in combination, using a variety of deployment systems as shown in FIGS. 3C and 3D. An ICE agent 306 entering, e.g., a cave or lava tube cave can establish robust communication to the base platform 303 (generally positioned on the surface, e.g., at the mouth of the cave (as illustrated in FIG. 3A) from varying depths within the cave or lava tube cave using the proposed DDCN comprising self-configuring wireless communication mesh nodes (i.e., the “Hansel & Gretel breadcrumbs”).

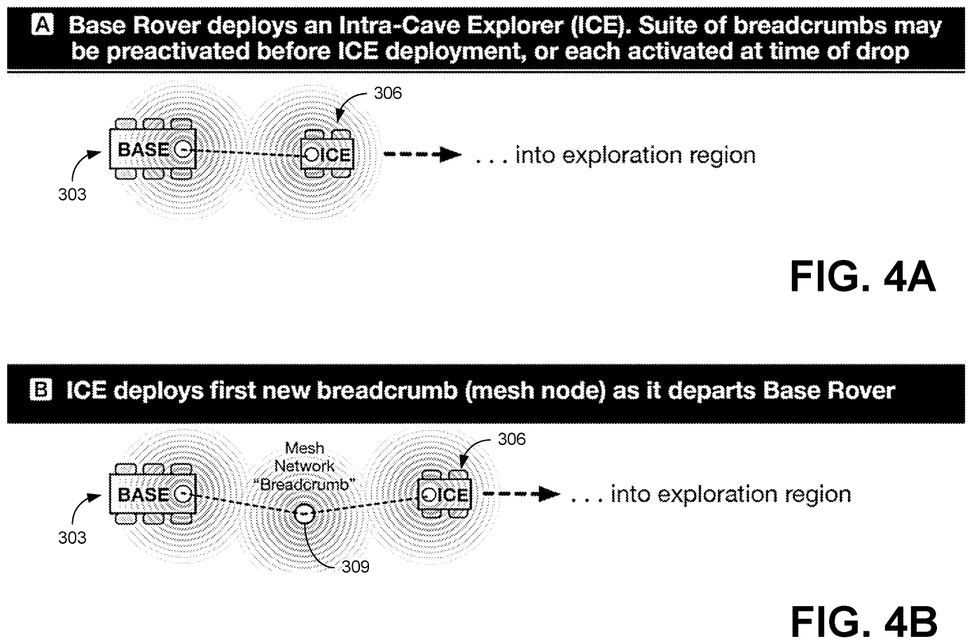

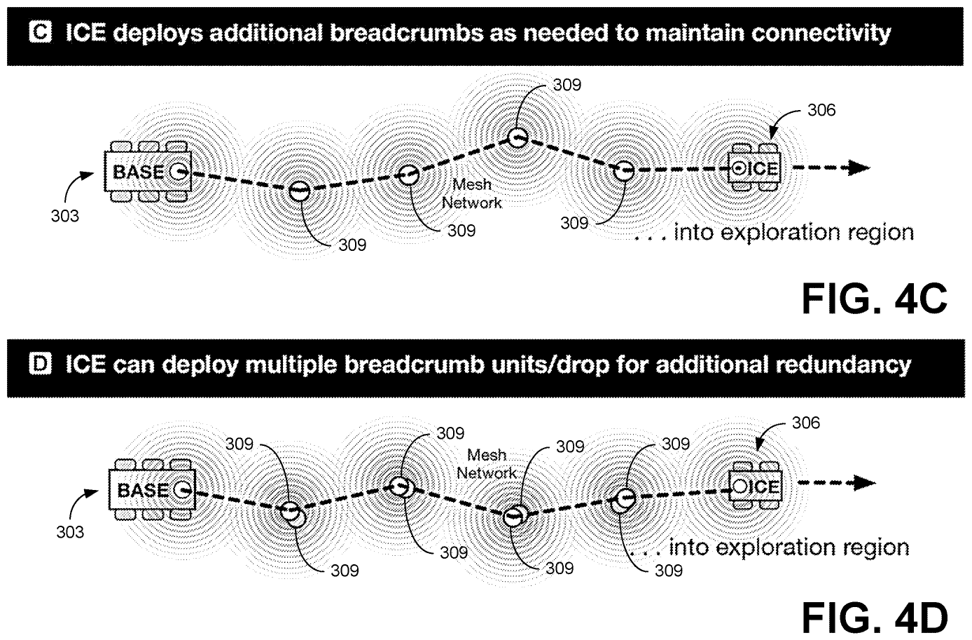

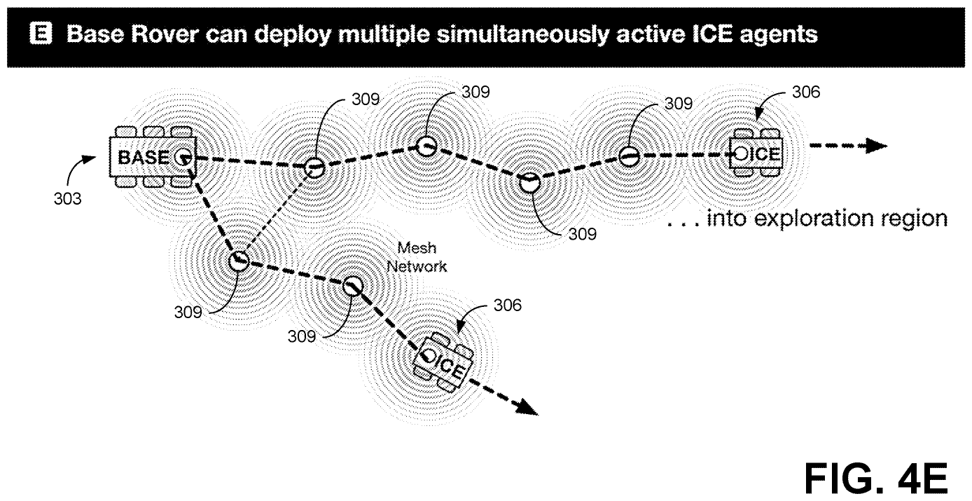

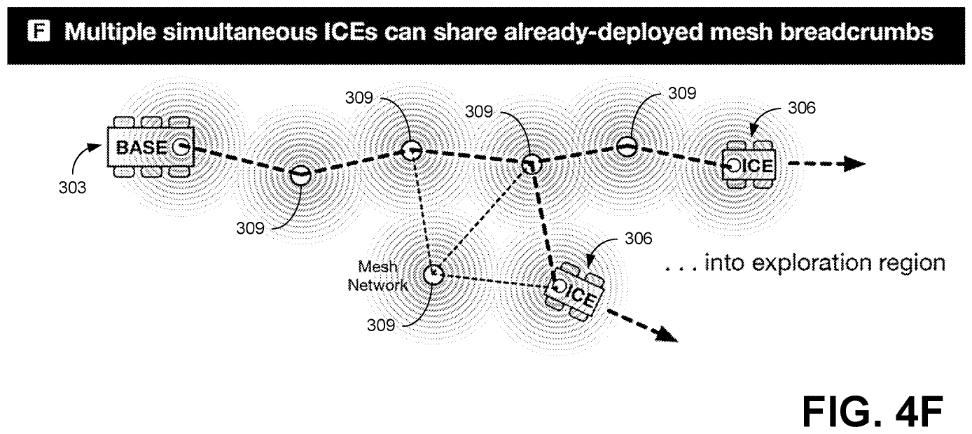

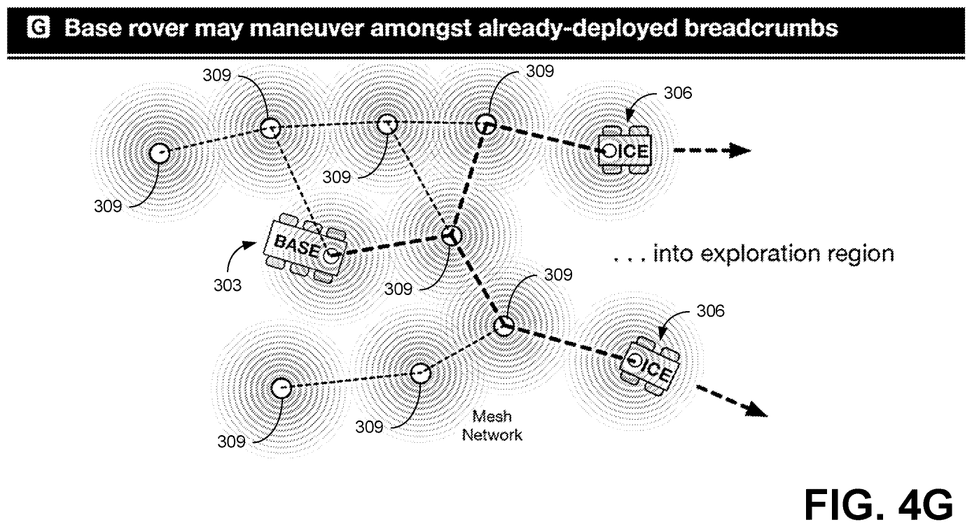

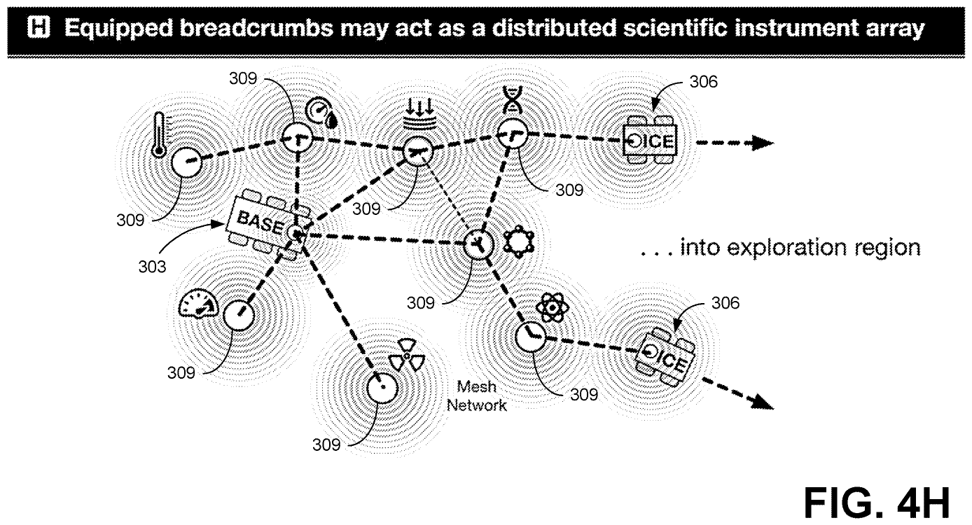

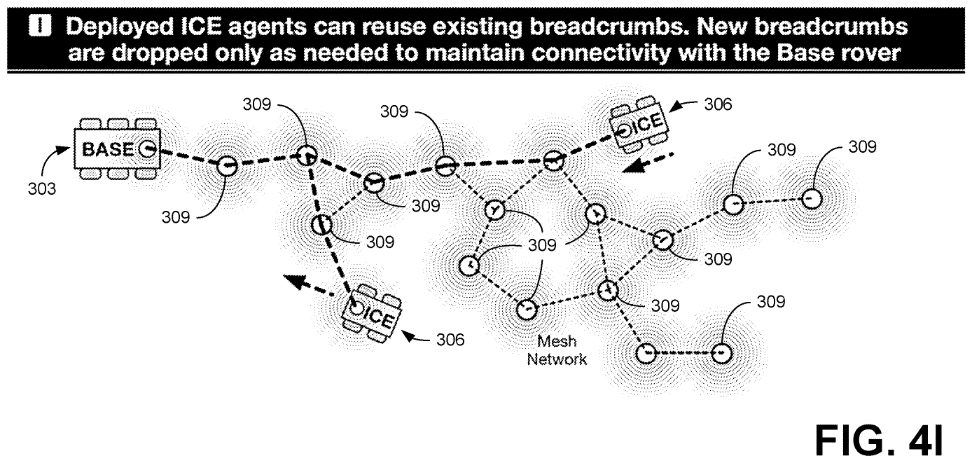

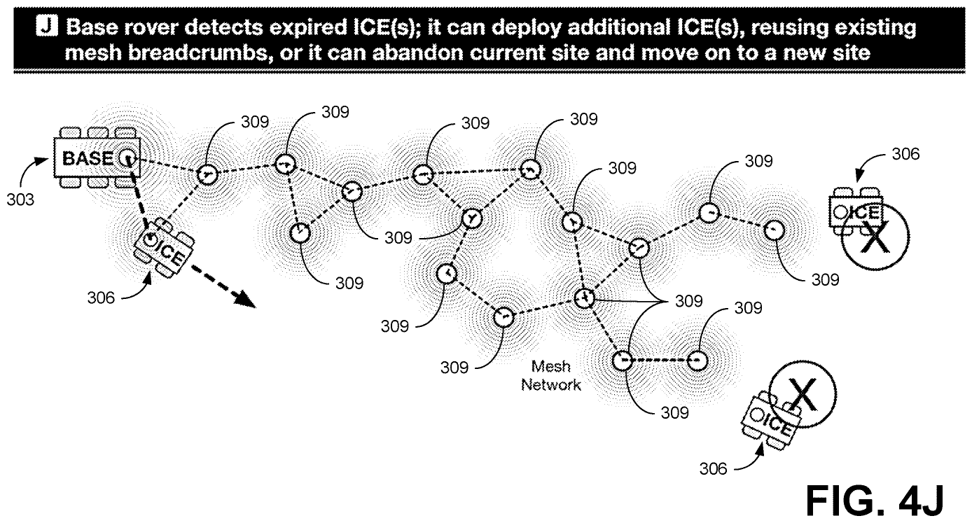

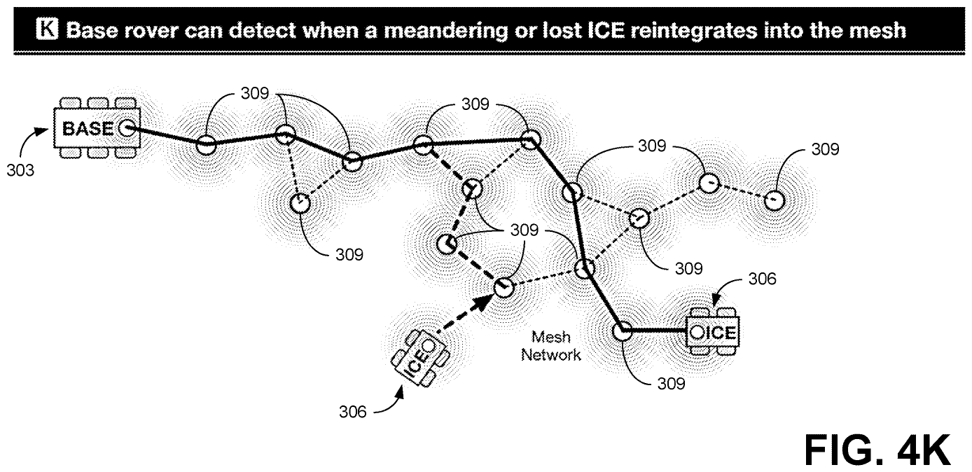

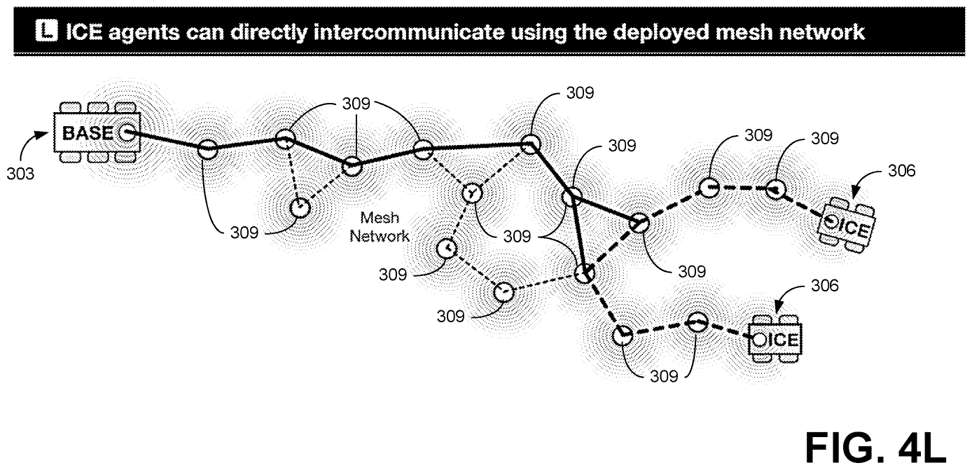

FIGS. 4A-4L illustrate examples of mesh network deployment scenarios. In FIG. 4A, the base platform 303 deploys an ICE agent 306 which can deploy a suite of active mesh nodes (“breadcrumbs”). The mesh nodes can be preactivated before ICE deployment or can be individually activated at the time of the drop. The mesh nodes can be autonomously deployed by the ICE agent(s) 306 based upon, e.g., a predefined plan and/or in response to one or more sensed conditions and/or control signals. For example, a mesh node can be deployed when the distance or signal quality to an adjacent mesh node reaches a defined threshold or is within a defined range. The threshold can be adjusted based upon, e.g., monitored communication signal strength or quality from the adjacent mesh node or changes in the path traveled by the ICE agent 306 or path options.

As shown in FIG. 4B, the ICE agent 306 can deploy a first mesh node 309 as it departs the base platform 303 or within a defined distance of the base platform 303 or when the signal quality degrades below a defined threshold. As the ICE agent 303 continues to travel along its path, it can continue to deploy additional mesh nodes 309 to maintain connectivity of the DDCN or as scheduled (FIG. 4C). In some cases, multiple mesh nodes 309 can be deployed at the same location as illustrated in FIG. 4D for redundancy, which can improve DDCN performance over time and avoid the need for an ICE agent 306 to subsequently redeploy a mesh node 309 at that location (e.g., by backtracking to that location). For example, an additional mesh node 309 can periodically monitor the condition of other deployed mesh nodes 309 and activate itself from a dormant mode (e.g., a sleep or low power state allowing for energy conservation) when defined conditions of the other mesh nodes 309 are met or not met. This can extend the power life of the other mesh nodes 309.

In some examples, the base platform 303 can deploy multiple simultaneously active ICE agents 306 to extend the DDCN along different paths as shown in FIG. 4E. The mesh nodes 309 deployed by a first ICE agent 306 maintain connectivity between adjacent mesh nodes 309. This connectivity can facilitate continued communication between the ICE agent 306 and the base platform 303. As a second ICE agent 306 deploys mesh nodes 309 along a second path, adjacent mesh nodes 309 along the second path maintain connectivity between each other. As shown in FIG. 4E, connectivity between mesh nodes 309 in different paths can also be established if they are within range of each other. One or more mesh nodes 309 along one path can be communicatively coupled to one or more mesh node 309 along another path, which can provide redundancy and robustness within the DDCN as illustrated in the example of FIG. 4F. Multiple simultaneous ICE agents 306 can share deployed mesh nodes 309.

The base platform 303 can stay in its initial location as the ICE agents 306 traverse across the area (FIG. 4F) or can maneuver amongst the deployed mesh nodes 309 as shown in FIG. 4G. Communications between the base platform 303 and one or more ICE agent 306 can transition between the deployed nodes as the base platform 303 and/or ICE agent(s) 306 change their position.

The mesh nodes 309 can also act as a distributed scientific instrument array, which can communicate information to the base platform 303 and/or one or more ICE agent 306 through the DDCN as illustrated in the example of FIG. 4H. For example, mesh nodes 309 can include sensors for detection and/or monitoring of temperature, pressure, humidity, or other environmental conditions such as, but not limited to, the presence of chemicals, substances, ions, biological matter or radiation.

As the ICE agents 306 traverse across the area, they can reuse existing mesh nodes 309 as illustrated in FIG. 4I. Additional mesh nodes 309 can be deployed as needed to maintain connectivity with the base platform 303. When the base platform 303 detects an expired ICE agent or agents 306, it can deploy another ICE agent 306 which can use the existing mesh nodes 309 of the DDCN as shown in FIG. 4J. In some cases, the base platform 303 can abandon the current site (leaving the active and/or expired ICE agent(s) 306) and move to a new site (FIG. 4J). The base platform 303 can also detect when an ICE agent 306 is lost or disconnected from the DDCN or can detect when a meandering or lost ICE agent 306 reintegrates with the DDCN as illustrated in FIG. 4K. The reintegrated ICE agent 306 can be one deployed by the base platform 303 in communication with the DDCN or can be deployed by a different base platform 303. The ICE agents 306 can communicate with the base platform 303 or can directly intercommunicate using the mesh nodes 309 of the DDCN as illustrated in FIG. 4L. The combination of solid lines plus thicker dashed lines shows examples of the communication paths of the ICE agents 306 with the base platform 303, and thicker dashed lines show an example of the direct intercommunication path between the ICE agents 306.

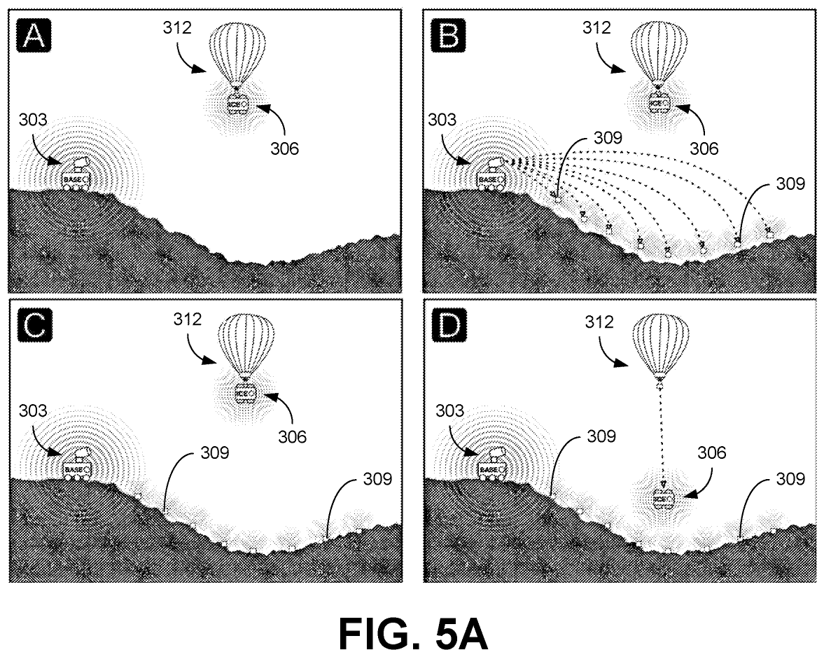

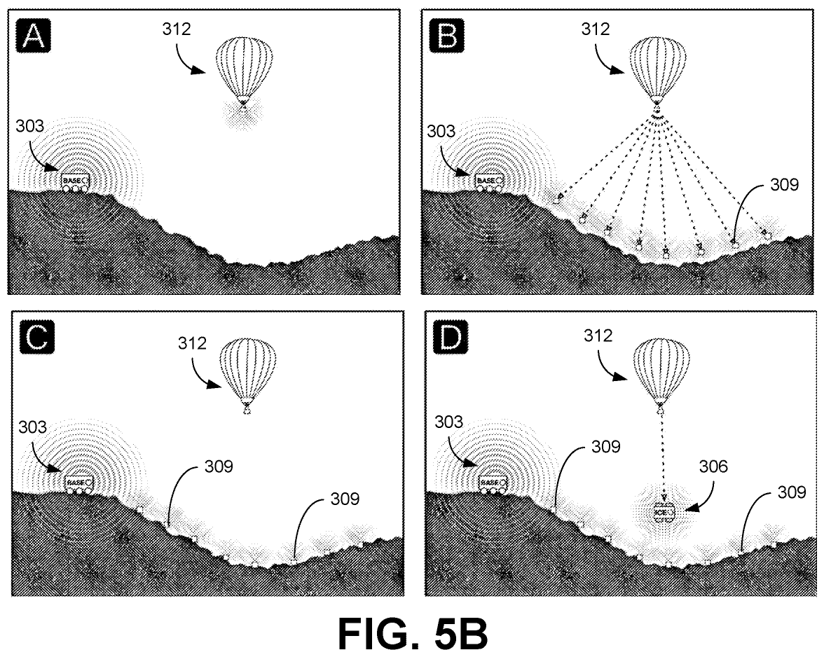

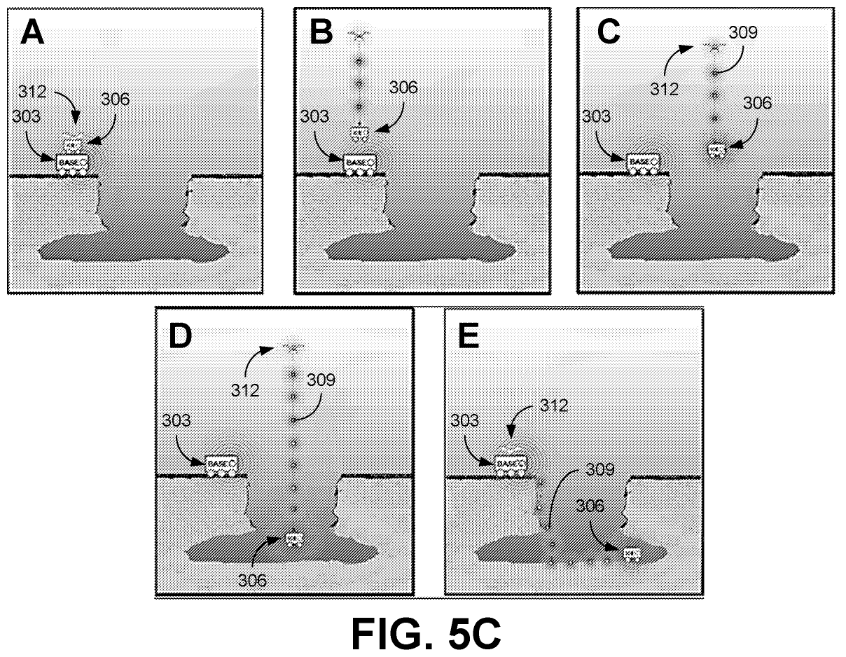

In some embodiments, mesh nodes 309 can be pre-deployed into or over an area. For example, one or more mesh nodes 309 can be pre-deployed from an aerial platform 312 and/or from the base platform 303 to initially establish the mesh network (FIGS. 5A and 5B). For instance, an area to be explored/reconnoitered can be pre-populated with mesh nodes 309 before deployment of an an ICE agent 306 to explore the area. This “scattershot” or “shotgun” modality allows a mesh network to be established and operate in, e.g., hazardous areas prior to the deployment of ICE units 306, relieving the ICE agents 306 of the responsibility of establishing/extending/maintaining the mesh network. The deployment of ICE agent(s) 306 need not be from the base platform 303. ICE agents 306 may be air-dropped into the area, relieving the ICE agents of the responsibility of traversing hazardous terrain (such, e.g., post-hurricane, tornado, or earthquake scenarios) to arrive at desired areas of interest.

FIGS. 5A-5C illustrate various examples of mesh network pre-deployment scenarios. In FIG. 5A, the base platform 303 can be configured to pre-deploy one or more mesh nodes 309 over an area of interest. The base platform 303 can include, e.g., a pressure mechanism (e.g., effected via spring, strut, compressed gas, liquid, electromagnetic field or pulse, etc.) that can distribute the mesh nodes 309 over the area. As shown in A of FIG. 5A, the base platform 303 can be manuvered to allow the mesh nodes 309 to be distributed over the area. The mesh nodes 309 can be projected about the area to provide coverage for the DDCN as illustrated in B of FIG. 5A. Once the mesh nodes 309 are deployed as shown in C of FIG. 5A, an ICE agent 306 can be deployed from the base platform 303, from an aerial platform 312 (e.g., balloon, helicopter, multicopter, etc.), or from both. In the example of FIG. 5A, an ICE agent 306 is deployed from a balloon and establishes communications with the base platform once it establishes a connection with one or more of the mesh nodes 309. The ICE agent 306, optionally, can deploy additional mesh nodes 309 to extend the mesh network or fill in gaps or improve network quality.

In the example of FIG. 5B, the aerial platform 312 can be configured to pre-deploy one or more mesh nodes 309 over an area of interest. The aerial platform 312 can include, e.g., a pressure mechanism (e.g., effected via spring, strut, compressed gas, liquid, electromagnetic field or pulse, etc.) that can distribute the mesh nodes 309 over the area.

As shown in A of FIG. 5B, the aerial platform 312 can be manuvered to allow the mesh nodes 309 to be distributed over the area. The mesh nodes 309 can be projected about the area to provide coverage for the DDCN as illustrated in B of FIG. 5B. Once the mesh nodes 309 are deployed as shown in C of FIG. 5B, an ICE agent 306 can be deployed from the base platform 303, from an aerial platform 312 (e.g., balloon, helicopter, multicopter, drone, etc.), or from both. In the example of FIG. 5B, an ICE agent 306 is deployed from the aerial platform 312 and establishes communications with the base platform once it establishes a connection with one or more of the mesh nodes 309. The ICE agent 306, optionally, can deploy additional mesh nodes 309 to extend the mesh network or fill in gaps or improve network quality. The mesh network can be extended via a combination of deployments of mesh nodes 309 on land and water (e.g., atop floating platforms). In this way, the mesh network can extend across intervening bodies of water.

Referring next to FIG. 5C, shown is an example of simultaneous deployment into a skylight. In the example of FIG. 5C, a base platform 303 with an ICE agent 306 and aerial platform (e.g., a multicopter, quadcopter, or drone) is maneuvered toward the skylight as shown in A of FIG. 5C. When in position, the aerial platform 312 can be used to lift the ICE agent 306 from the base platform 303 and deploy the ICE agent 306 over the skylight as illustrated in B and C of FIG. 5C. The ICE agent 306 can be lifted with a cable or other support that includes one or more mesh nodes 309 as shown. Once the ICE agent 306 is located on the floor of the skylight as shown in D of FIG. 5C, the aerial platform 312 can return to the base platform 303 laying out the mesh nodes 309 to establish the mesh network between the ICE agent 306 and the base platform 303 as illustrated in E of FIG. 5C. In some cases, one or more helicopters/multi-copters can enter a skylight (or cave, lava tube cave, underground mine working or other tunnel system) and can subsequently be utilized in place of ground based ICE agents 306. The mesh-node-equipped helicopter/multi-copter can form in part a hovering communication chain (DDCN) down the skylight, and some other mesh-node-equipped helicopters/multi-copters can explore the caves, lava tube caves, or underground mine workings instead of ground-based agents, i.e., pure aerial exploration of subsurface voids if the (planetary) environment supports dense enough of an atmosphere. In some cases, the base platform 303 or aerial platform 312 can deploy mesh nodes 309 into the skylight as illustrated in FIGS. 5A and 5B. Aerial platforms such as multicopters, quadcopters, drones, etc. can also be used to pre-deploy mesh nodes 309 in caves, lava tube caves, underground mine workings or tunnel systems before deployment of ICE agents 306.

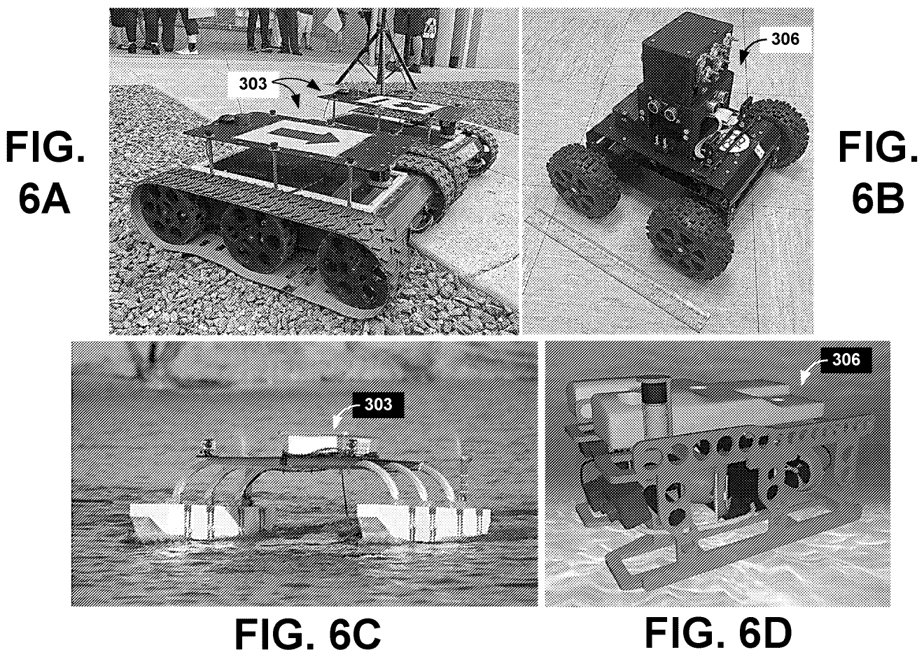

The images of FIGS. 6A-6D illustrate various examples of base platforms 303 and ICE agents 306. FIG. 6A shows two base platforms 303 within an established Tier-Scalable Reconnaissance (TSR) multi-platform testbed. See, e.g., “Multi-Rover Test Bed for Tele-Conducted and Autonomous Surveillance, Reconnaissance, and Exploration” by W. Fink and M. A. Tarbell (Proc. SPIE 2009; Vol. 7331, 73310B, 2009); “Robotic Test Bed for Autonomous Surface Exploration of Titan, Mars, and Other Planetary Bodies” by Fink et al. (IEEE Aerospace Conference Proceedings, paper #1770, Big Sky, MT, 2011); and “Tier-Scalable Reconnaissance: The Future in Autonomous C4ISR Systems has arrived—Progress towards an Outdoor Testbed” by Fink et al. (Proc. SPIE 10194, Micro- and Nanotechnology Sensors, Systems, and Applications IX, 1019422. May 2017). Each base platform 303 can be equipped with an onboard computing systems, such as, but not limited to, single-board computing platforms, such as, but not limited to, a Raspberry Pi, or a dual-core, high-performance UNIX workstation, or other appropriate CPU and can be fitted with one or more sensors such as, e.g., LIDAR and/or GPS (in the case of terrestrial applications) sensors. In FIG. 6B, an intra-cave-explorer (ICE) agent is shown with sensors and an illumination assembly. A robotic lake lander, shown in FIG. 6C, taking on the role of the base platform but for liquid environments (lakes, rivers, oceans, etc.), can be equipped with the same computing system(s) and sensors as the above base platform 303. FIG. 6D shows an example of an autonomous underwater vehicle (UAV) or underwater research vehicle, or remotely operated vehicle (ROV) hybrid, i.e., the intra-liquid-explorer (ILE), utilized within the DDCN. Both, the ICE and ILE can be equipped, e.g., with single-board computing platforms, e.g., the Raspberry Pi, for limited onboard autonomous navigation as well as gathering of science or other investigation data of interest. Payload-permitting, space-permitting, and/or power-permitting the ICE and ILE can also be equipped with higher powered computing systems, similar or identical to the base platform or robotic lake lander in yet another example.

### Wireless Dynamically Deployed Communication Network (DDCN)

The DDCN comprises one or more wireless communication nodes or mesh nodes 309 that form a link between the ICE agent(s) 306 and base platform(s) 303. A proof-of-concept instantiation has selected Wi-Fi as the base communication protocol because the mesh network of microcontrollers used in this implementation was built atop the Wi-Fi protocol, which offers a high data rate and off-the-shelf availability. The final chosen protocol for actual missions may be Wi-Fi or another alternative wireless technology (see below).

Multiple wireless mesh nodes 309 can be used for intra-cave communication as has been discussed. The DDCN can be intelligently established on-demand using an autonomous distributed robotic system, e.g., Tier-Scalable Reconnaissance (TSR). See, e.g., “20 Years of Tier-Scalable Reconnaissance: Adoption of a Game-changing Mission Paradigm” by Fink et al. (IEEE Aerospace Conference Proceedings, paper #2886, Big Sky, MT, 2022). Note that the DDCN paradigm is applicable to various other methods of wireless communication including, e.g., Bluetooth (Bluetooth Low Energy, BLE); Zigbee; Infrared Wireless (IrDA);

Ultra Wideband (UWB); Induction Wireless (IW); Laser/Maser/Optical; Vehicle-to-Everything (V2X); Low-Power Wide-Area (LPWA); Software-Defined Radio (SDR); Ethernet Interface Radio Modem or TCP/IP radio modem on UHF, VHF, or ISM Band; Backscatter Networking; cellular standards (e.g., 5G); or other appropriate wireless technologies. A mix of two or more wireless technologies may also be employed in yet another example. The feasibility of Wi-Fi communication at plausible data rates for robotic exploration 100s of meters within a basalt lava tube cave was simulated but was shown to vary widely and unpredictably with the tested cave's specific geometry, thus validating the need for autonomous terrain-driven dynamic deployment of ad hoc mesh nodes 309.

### Technical Implementation of the Wireless Mesh Nodes

The DDCN can be established autonomously by the base platform 303 (see, e.g., FIG. 6A) using at least one ICE agent 306 (see, e.g., FIG. 6B) through in-situ placement of multiple energy-efficient Wi-Fi nodes or other wireless mesh nodes 309—the “Hansel & Gretel breadcrumbs”—within an established or ad hoc region to be explored to relay information out to the base platform 303.

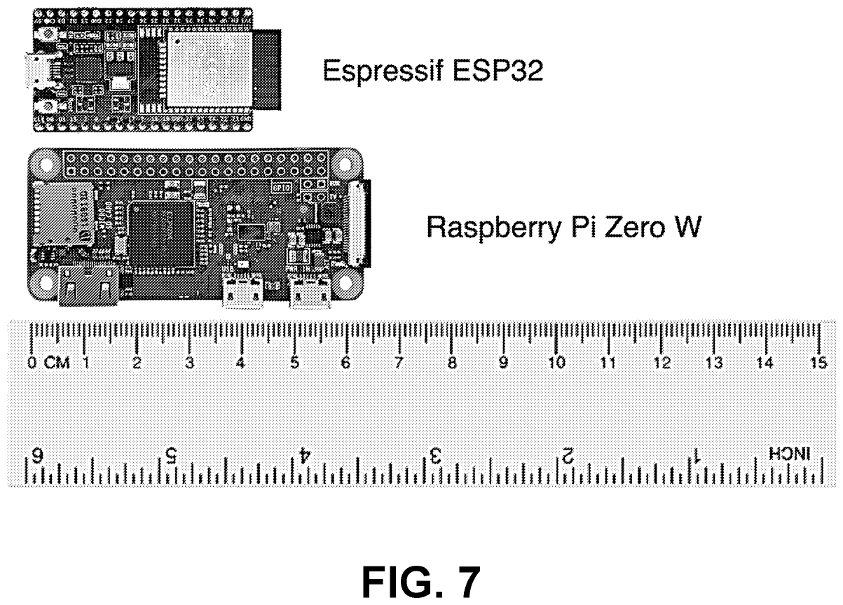

In one example, and as a potential functional instantiation, the mesh nodes 309 can be, for example, Espressif ESP32-based microcontrollers (Espressif, “ESP-IDF Programming Guide”, Espressif Systems Co., Ltd; Espressif, “ESP-MDF Programming Guide”, Espressif Systems Co., Ltd). In another example, the mesh nodes 309 can be one of Raspberry Pi units, other single-board computing platforms, or a heterogeneous mix of two or more single-board computing platforms. Each mesh node 309 can be a wireless module to enable orientation independent, omnidirectional communication between multiple neighboring mesh nodes 309, forming a mesh topology. ESP32s are small, low-cost, power-efficient system on chip (SoC) series with a dual- or single-core Xtensa 32-bit LX6 microprocessor running a modified FreeRTOS kernel and containing built-in 802.11b/g/n 802.11n up to 150 Mbps Wi-Fi, Bluetooth V4.2, and Bluetooth Low Energy connectivity. FIG. 7 is an image of an Espressif ESP32-based microcontroller for ad hoc mesh network communication. The main advantages of ESP32s are their small size, low weight (˜10 g), and programmable mesh networking capabilities implemented via the Espressif Mesh Development Framework (Espressif, “ESP-MDF Programming Guide”, Espressif Systems Co., Ltd). Note that ESP32s, Raspberry Pi Zero Ws, other hardware, or a combination of two or more different hardwares may be utilized for the actual communication mesh nodes that can be deployed in exploration missions. Other mesh nodes exhibiting similar technical, physical, computational, and power specifications can be utilized.

The DDCN can be utilized to operate the ICE remotely, in real time, using the base platform's onboard computer(s). Under a “Godfather control paradigm,” the remote-controlled ICE can be an extension of the base platform, e.g., its “eyes and ears,” allowing for the exploration of extreme subsurface environments using computational power which is either too large or too mission-critical to risk introducing to a subsurface environment. Support of two independent root-access points by the microcontroller (e.g., Raspberry Pi) can allow implementation of the “Godfather control paradigm,” thereby allowing bidirectional communication between the base platform and the ICE. The exact same “Godfather control paradigm” scenario can apply to the ILE being remotely operated/controlled by the lake lander.

### Establishing the Wireless DDCN Breadcrumb Chain Using Mesh Topology

The DDCN breadcrumb chain establishes communications between the base platform 303 and ICE agent(s) 306 via the deployment of “breadcrumbs,” i.e., intermediary mesh nodes 309. The deployment of each mesh node 309 is agnostic of the actual communication protocol which transmits information throughout the mesh in the DDCN. Following initial deployment from a base platform 303, each ICE agent 306 can traverse as deeply as possible into a cave, lava tube cave, or underground mine working until the communication link quality with the base platform 303, fitted with its own dedicated onboard mesh node, drops below a threshold (e.g., a pre-defined and constantly monitored nominal Received Signal Strength Indicator (RSSI) threshold). The threshold can be chosen to be still above a derated (e.g., user-defined), absolute minimum RSSI threshold. The ICE agent 306 can then deploy a self-powered mesh node 309 that extends the mesh network, acting as a go-between link between the ICE agent 306 and the base platform 303 (or between the ICE agent 306 and other ICE agents 306). When a newly deployed mesh node 309 has been verified as an active, functional part of the mesh network chain (with, e.g., an RSSI above the nominal threshold), the ICE agent 306 can continue deeper into the cave, lava tube, or underground mine working. If, per chance, the new mesh node 309 does not perform (e.g., RSSI is below nominal), the ICE agent 306 may reposition itself and drop another mesh node 309, repeat the verification process, and move on. This “breadcrumb” deployment scenario can repeat until all (or a predefined number) of the mesh nodes 309 have been deployed. The deployed mesh nodes 309 can relay information between the ICE agent 306 and base platform 303 by creating an ad hoc multi-segment mesh communication network—the DDCN—between each ICE agent 306 and the base platform 303. Even if the ICE agent 306 should travel beyond the reach of the deployed mesh network, it can detect this condition and reverse its course to reestablish communication with the network, and proceed as above.

The operational lifespan of the entire “breadcrumb” chain depends on the power supply (e.g., battery life, capacitor charge, Radioisotope Thermoelectric Generators (RTGs) status, etc.) of the deployed mesh nodes 309. In one example, for simplicity, the mesh nodes 309 can be powered on when each ICE agent 306 deploys from the base platform 303. In alternative scenarios, each mesh node 309 can be powered on at the time of its actual deployment onto the surface for longer useful power expenditure. Note, that an additional level of communication redundancy can be achieved if multiple mesh nodes 309 are dropped with each deployment occasion. It should be noted that the duration of the mission and DDCN can depend on the lifetime of the first deployed mesh node 309 and/or another mesh node 309 needed to maintain communication between each ICE agent 306 and the base platform 303 (or between each ICE agent 306 and other ICE agents 306). To maintain operation of the mesh, an additional mesh node 309 may be deployed to “replace” the first mesh node 309 and/or another needed mesh node 309, or the position of the base platform 303 may change allowing it to maintain communications through other deployed mesh nodes 309 of the network.

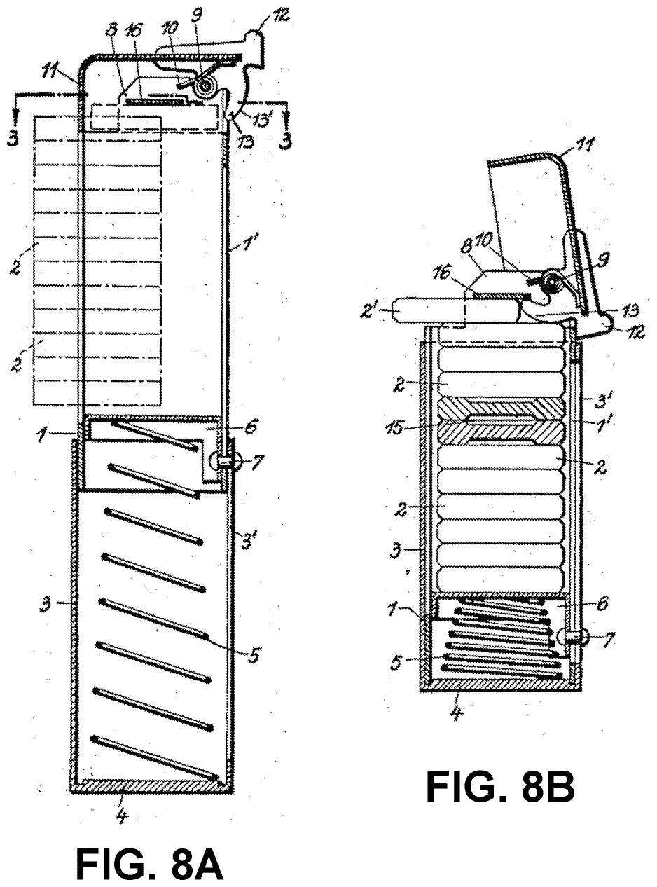

As for the actual deployment of the individual mesh nodes 309, one possible deployment mechanism comprises loading numerous mesh nodes 309 into a magazine or storage area/compartment or storage on the ICE agents(s) 306, where, e.g., a pressure mechanism (e.g., effected via spring, strut, compressed gas, liquid, electromagnetic field or pulse, etc.) can push them to an electric actuator that ejects and/or deploys the “loaded” mesh node 309 into the exploration region or area. In another example, a robotic arm can pick up a mesh node 309 from a storage area/compartment or storage on the ICE agent(s) 306, and place it into the exploration region or area. In yet another example, a mesh node 309 could be catapulted from at least one of the base platform or the ICE agent(s) 306 into the exploration region or area. Other deployment mechanisms can also be used as can be understood. FIGS. 8A-8B illustrate an example of a linear magazine that can be used to dispense individual mesh nodes 309. A discharge mechanism such as the lever illustrated in FIG. 8B can be rotated to expel the mesh node 309 from the magazine. Pressure exerted from the bottom of the magazine can secure the top most mesh node 309 in the stack in position for deployment. Other deployment arrangements can also be used as can be understood.

The mesh nodes 309 can create a robust, reconfigurable, self-healing wireless mesh network, which can be extended and maintained automatically. In this way, the mesh communication nodes 309 can act as omnidirectional relays as they maintain multiple upstream and downstream connections simultaneously. In a generic deployment scenario, this can be used to create a standard tree topology where each mesh node 309 connects to a single parent node and contains one or more child or leaf node(s). However, in a cave, lava tube, or underground mine working scenario, the mesh network can be utilized primarily to form an adaptive, self-healing, self-extending, end-to-end communications stream between each ICE agent 306 and base platform 303.

Each mesh node 309 in the mesh network can have a downstream connection (i.e., towards an ICE agent 306) and automatically transmits wireless frames to detect possible upstream connections (i.e., towards a base platform 303) and inform nearby mesh nodes 309 of its presence and status. If a mesh node 309 has multiple possible upstream connections, it can automatically determine a preferred parent node. One such instantiation of this determination can be based, e.g., on the candidate parent node's current layer (i.e., how many upstream connections to the root node) and how many downstream connections currently exist from that candidate parent node. Parent nodes can be preferred that are the shallowest within the tree, which minimizes the total number of layers. If two or more candidate parent nodes are within the same layer, the mesh node 309 with the least number of downstream connections can be selected. The link signal quality of each candidate parent's node can also be taken into consideration for this determination. Thus, the preferred parent node assignment may change over time.

Communication through the mesh network can be possible in either a broadcast (undirected) or point-to-point (targeted) transmission. Each mesh node 309 within the mesh network can automatically construct and maintain a routing table, which can be used to transmit packets within that node's subnetwork. The routing table can then be used to determine whether a packet should be forwarded upstream or downstream. For example, the ICE agent 306 can utilize point-to-point communication transmissions, starting at its dedicated onboard mesh node 309, traveling through the “breadcrumb” path of mesh nodes 309 of the mesh network at large, and finally reaching the dedicated onboard mesh node of the base platform 303.

The ultimate destination of the point-to-point mesh packets can be a network access point (AP) running on each base platform 303 and ICE agent 306. The mesh network can be bridged to the base platform's and ICE agent's AP by an appropriately configured mesh node. This dedicated mesh node can ride aboard each base platform 303 and ICE agent 306 and can bridge packets between the mesh network and the APs. Once received by the base platform AP, it can choose to forward the packets on to an orbiter, to agents/robots of a Tier-Scalable Reconnaissance-type distributed robotic system, to another base unit, to Earth, or to other remote computing device(s). The point-to-point packets the ICE agent(s) 306 receive are generally command packets sent from the base platform 303—especially when using the “Godfather control paradigm”—but can also include status, information, and other packet types from other ICE agent(s) 306, and also from any mesh nodes acting as environmental sensors (FIG. 4H). The packets the base platform 303 receives from the ICE agent(s) 306 generally carry science data, imaging, sensory, and/or telemetry information.

### Underwater Wireless Communication Challenges

Having covered the DDCN in a wireless capacity as it applies to terrestrial/planetary subsurface exploration, the same mechanism can be applied to liquid-based subsurface environments, e.g., as found on Earth or on extraterrestrial ocean worlds (e.g., Europa, Titan, and Enceladus). In this case the data transmission environment is liquid rather than gaseous or vacuum, but now the path from base platform 303 to explorer or agent 306 may be less convoluted. Nevertheless, the method of long-distance communication across a challenging space remains the same. The proposed DDCN, detailed above for caves, lava tube caves, or underground mine workings, is also applicable to underwater exploration. In the following, the role of the base platform 303 is replaced with a potential lake lander or surface-based lander (see, e.g., FIG. 6C), and the role of the ICE agent 306 is replaced with an Intra-Liquid Explorer (ILE) agent such as, e.g., a submersible/underwater research vehicle (see, e.g., FIG. 6D). Paralleling the above terrestrial/planetary surface/subsurface exploration modes (FIGS. 4A-4L), the following modes of aquatic communication can likewise be effected: (a) surface to surface, (b) surface to subsurface, (c) subsurface to surface, and (d) subsurface to subsurface.

For underwater monitoring, underwater wireless network systems (UWNSs) can be used. There are at least three principal ways by which wireless communication can be carried out underwater: (1) acoustically, (2) via radio frequency (RF), and/or (3) optically. These methods of wireless communication have been listed in decreasing order of reliable communication distance, but due to increased energy, also in order of increasing sensitivity to environmental factors, such as water turbidity or salinity, and in order of increasing data bandwidth. Among the three communication options, RF has a peculiar advantage over both acoustic and optical transmission in that it can cross the water-air barrier and is generally not strongly affected by particulate presence in water. However, its short range makes it less popular than acoustic communication, which enables a subset of UWNSs called underwater acoustic sensor networks (UW-ASNs) to perform tasks such as ocean sampling, environmental monitoring, and undersea exploration in various capacities.

Nevertheless, the current approach to using acoustics falls into a passive data-relay role wherein entities such as autonomous underwater vehicles and seafloor sensor clusters relay their findings back to surface sinks (i.e., to data storage and processing centers), solely because acoustics are highly bandwidth-limited to ˜20 kb/s. Optical communication is not so much affected by attenuation, especially compared to RF or acoustics, but is instead very susceptible to scattering. This scattering effect necessitates high-precision alignment between the laser source and the receiver, the use of narrow lasers, and is therefore less desirable compared to RF.

### Applications beyond Planetary Exploration

The need to deploy subterranean robotic probes which maintain communication extends to applications on Earth in addition to extraterrestrial planetary exploration. For example, the DARPA Subterranean Challenge seeks to advance technologies needed to traverse natural and man-made subterranean environments, e.g., tunnel systems and urban underground environments, in support of warfighters within the theatre or first responders in a disaster area. Among many other focus areas, this challenge seeks to address communication paradigms involving wireless repeater networks. Rather than deploying “breadcrumbs” at a constant distance interval to establish a deterministic wireless mesh, the mesh nodes 309 can be deployed dynamically and opportunistically utilizing the currently available resources to establish a wireless mesh that is adaptive and responsive to the constraints imposed by the unknown environment. In addition to military and disaster scenarios, subterranean vehicles and their accompanying communication paradigms are also applicable to oil, gas, and mining industries—both on Earth and the Moon, Mars, etc.—as they adopt more automation and robotics within their existing infrastructure.

In terrestrial applications, where multiple subterranean vehicles are more likely to occupy a given space than in planetary caves or lava tube caves, the wireless DDCN can be leveraged by multiple ICE agents 306, each with their own store of mesh nodes 309, to communicate amongst each other and to the surface through the DDCN.

For the exploration (and mining) of caves on asteroids, moons, comets, and other low-gravity bodies, the deployment of mesh nodes 303 to establish a wireless DDCN can be performed by “airborne”, floating spacecraft (e.g., equipped with cold gas thrusters). The Earth analog would be airships, dirigibles, balloons, blimps, zeppelins, helicopters, quad-or multi-copters, etc. for the exploration of, e.g., underground mine workings (e.g., tunnels, shafts, etc.) or other natural of man-made subterranean environments, e.g., tunnel systems and urban underground environments, in support of warfighters within the theatre or first responders in a disaster area. Airships, dirigibles, balloons, blimps, zeppelins, helicopters, quad-or multi-copters, etc. could also be deployed on planetary bodies with sufficiently dense atmospheres.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method, comprising:
deploying an agent in communication with a base platform;
traversing an area by the agent, wherein one or more mesh nodes deployed in the area form a dynamically deployed communication network (DDCN); and
maintaining communication between the agent and base platform via at least a portion of the one or more deployed mesh nodes of the DDCN.

2. The method of claim 1, wherein the one or more mesh nodes are autonomously deployed by the agent during traversal of the agent in the area.

3. The method of claim 1, wherein the one or more mesh nodes are autonomously deployed prior to traversal of the agent in the area.

4. The method of claim 3, wherein the one or more mesh nodes are autonomously deployed by an aerial platform or by the base platform.

5. (canceled)

6. The method of claim 3, wherein at least one additional mesh node is autonomously deployed by the agent during traversal of the agent in the area.

7. The method of claim 1, wherein the agent is deployed by the base platform or by an aerial platform.

8. (canceled)

9. The method of claim 1, wherein the agent is an intra-cave-explorer (ICE) agent or an intra-liquid explorer (ILE) agent.

10. The method of claim 2, wherein the agent deploys a mesh node in response to a received signal strength from the base platform or from an adjacent mesh node of the DDCN.

11. The method of claim 10, wherein the agent deploys the mesh node when the received signal strength falls below a defined threshold.

12. The method of claim 10, wherein the agent deploys two mesh nodes in response to the received signal strength.

13. The method of claim 7, comprising:
deploying another agent from the base platform;
traversing the area by the other agent, wherein at least one mesh node is autonomously deployed by the other agent at a different location during the traversal of the other agent, the at least one mesh node extending the DDCN; and
maintaining communication between the other agent and base platform via the at least one mesh node.

14. The method of claim 13, wherein the at least one mesh node is in communication with a mesh node of the one or more deployed mesh nodes.

15. The method of claim 14, wherein the other agent maintains communication with the base platform via at least a portion of the one or more deployed mesh nodes while traversing the area before deploying the mesh node.

16. (canceled)

17. The method of claim 7, comprising traversing the area by the base platform after deployment of the agent, wherein communication between the agent and base platform is dynamically maintained via the DDCN.

18. The method of claim 1, wherein the one or more deployed mesh nodes form a distributed instrument array configured to provide sensor information to the base platform or to one or more agent via the DDCN.

19-21. (canceled)

22. The method of claim 2, wherein the agent comprises a magazine configured to store and deploy the one or more mesh nodes.

23. The method of claim 22, wherein the magazine is a pressure operated magazine that dispenses the one or more mesh nodes.

24. (canceled)

25. (canceled)

26. The method of claim 1, wherein the base platform remotely controls operation of the agent.

27. The method of claim 1, wherein the base platform and at least one deployed agent have bidirectional information exchange.

28. The method of claim 1, wherein the deployed agent and at least one other deployed agent have bidirectional information exchange.
